(19) United States
(12) Patent Application Publication
(10) Pub. No.: US 2015/0101756 A1
(43) Pub. Date: Apr. 16, 2015

(54) PROCESS

(71) Applicant: UNIVERSITY OF LEEDS, Leeds, West Yorkshire (GB)

(72) Inventors: Carl Anthony Lawrence, Halifax (GB); Hassan Mohamed El-Dessouky, Leeds (GB)

(73) Assignee: UNIVERSITY OF LEEDS, Leeds, West Yorkshire (GB)

(21) Appl. No.: 14/402,641

(22) PCT Filed: May 17, 2013
(86) PCT No.: PCT/GB2013/051279

§ 371 Date: Nov. 20, 2014

(30) Foreign Application Priority Data
May 22, 2012 (GB) 1209043.7

(51) Int. Cl. B29C 70/30; D06M 15/19; B29C 70/06

(52) U.S. Cl. CPC B29C 70/305; B29C 70/06; D06M 15/19; B29K 2101/12
USPC 156/390; 427/180; 118/308; 442/179

(57) ABSTRACT

The present invention relates to a process and assembly for preparing a dry thermoplastic prepreg comprising reinforcing fiber spread tow (2) and airborne or melt-borne discrete thermoplastic fibers (4).

The present invention relates to a process and assembly for preparing a dry thermoplastic prepreg, to a method for fabricating a reinforced thermoplastic composite and to the dry thermoplastic prepreg and reinforced thermoplastic composite per se.

Thermoplastic composites having continuous fibre reinforcements are of increasing interest in view of their many potential advantages over the more widely used thermoset composites. These advantages include (for example) fracture toughness and damage tolerance (higher strain to failure), ease of shape forming prior to consolidation, significantly faster and lower cost manufacturing, freedom from solvents allowing them to be stored in any ambient environment with infinite shelf life and the ability to be repaired, reshaped, reused or recycled. More generally there is an increasing demand for lighter weight composites involving better utilisation of the reinforcing fibre (typically carbon fibre (CF)) to achieve cost benefits.

Sangwook Sihn et al, Experimental Studies of Thin-ply Laminated Composites, Composites Science and Technology, 67 (2007), 996-1008 disclose a technique for achieving lighter weight composites known as spread tow technology. Using this technique, the filaments of a 12K CF tow (ie 12000 filaments) are thinned by increasing the width of the tow from 5 mm to around 25 mm thereby reducing the weight per unit area (compactness) by approximately 500%. Since the filaments are more widely spaced, the handling of spread tows is difficult and stabilization is needed to prevent the spread tow (or a sheet of spread tows) from becoming disarranged prior to processing. Owing to these handling difficulties, the use of spread tow is currently limited to thermoset composites.

Advanced thermoplastic composites are commonly manufactured from prepregs in which the reinforcing fibres are assembled in unidirectional form (UD) or as a woven fabric and then pre-impregnated with a thermoplastic resin (see for example I. Y. Chang and J. K. Lees, Recent Development in Thermoplastic Composites: A Review of Matrix Systems and Processing Methods, Journal of Thermoplastic Composite Materials, 1988, 1-277).

U.S. Pat. No. 6,616,971 discloses high quality lightweight composites and methods for their formation from fibres such as glass, polyaramid or graphite. The composites incorporate a polymer matrix embedding individual fibres and exhibit enhanced strength and durability. The polymer matrix is a thermoplastic or other polymer that cannot easily penetrate gaps between individual fibres by methods typically used for thermosets.

US-A-2009/0309260 is concerned with a process comprising (a) providing a reinforcing fibre bundle layer which contains a thermoplastic and/or crosslinking resin within the fibre bundle, (b) providing a layer of a thermoplastic and/or crosslinking material on at least one side of the high modulus layer formed in step (a) and (c) compressing the layers formed in step (b) under an appropriate amount of heat and pressure to produce a prepreg of high modulus reinforcing fibres.

The most commonly used methods for producing prepregs are film calendaring, solution dip prepregging and dry powder-melt impregnation.

K. E. Goodman and A. C. Loos, Thermoplastic Prepreg Manufacture, Journal of Thermoplastic Composite Materials, 1990, 3:34 disclose a film calendaring method in which a thin thermoplastic film is laid onto an assembly of reinforcing fibres, melted and infused into the assembly under high pressure by heat-calendering.

Solution dip prepregging involves passing a fibre assembly through a thermoplastic polymer slurry dissolved in a solvent that is subsequently evaporated near the end of the process or during melt impregnation. U.S. Pat. No. 5,019,427 discloses methods for producing fibre reinforced thermoplastic materials having substantially reduced amounts of fibre breakage and substantially increased tensile strength. Relatively large diameter rollers are typically used to guide filaments through a slurry bath of powdered resin and spray header means are provided in the slurry bath to forcefully contact the filaments with the resin in the slurry. Similarly U.S. Pat. No. 5,725,710 discusses the production of fibre-reinforced composites by pulling a continuous fibre strand through an agitated aqueous thermoplastic powder dispersion via deflectors. Following removal of the water phase, the thermoplastic powder is heated and melted onto the fibres. Finally the fibre strand is impregnated with a thermoplastic melt by melt pultrusion.

Dry powder-melt impregnation relies on impregnation of the fibre assembly by a suspension of fine polymer particles (<5 micrometres) which are then melt-infused into the fibres. U.S. Pat. No. 4,559,262 discloses fibre-reinforced structures comprising a thermoplastic polymer and reinforcing filaments extending longitudinally. The structures are produced in a continuous process and have exceptionally high stiffness which results from thorough wetting of the reinforcing filaments by molten polymer. The wetting gives rise to a product which can be further processed in vigorous mixing steps such as injection moulding with high retention of fibre length in the fabricated article.

The most significant drawback of thermoplastic composites is the very high viscosity (500-5000 Pa) of thermoplastic polymers at the relevant processing temperature. In order to ensure that the void percentage of the composite part is minimal, it is important that the resin-flow distances are as short as possible. Hence there is a requirement to totally wet-out the reinforcing fibres by melt pre-impregnation of the prepreg. Dry-powder melt pre-impregnation is the most effective technique for UD whilst film calendaring is the most suitable technique for woven fabric.

When the reinforcing fibres are assembled in UD form, the prepreg is referred to as a tape and is provided as rolls of wide UD tape (>250 mm). When reinforcing fibres are assembled as a woven fabric, the loom-state width is retained and the prepreg is provided as rolled sheets. In order to circumvent difficulties in handling UD prepregs, processes aim to fully impregnate the fibre assembly. As discussed by Jonas Bernhardsson and Roshan Shishoo, Effect of Processing Parameters on Consolidation Quality of GF/PP Commingled Yarn Based Composites, Journal of Thermoplastic Composite Materials, 2000, 13:292, this results in a relatively stiff tape even though it can be rolled. UD prepregs are therefore more suited to forming laminates which can then be formed into composite shapes by thermoforming.

Attempts have been made to produce partially impregnated prepreg tape for improved drapeability but no such commercial product is yet available. Woven prepreg can be handled in the partially impregnated state which makes it suitable for directly forming complex composite shapes. However the mechanical properties of UD prepreg are significantly superior to those of woven prepreg.

Further attempts to accommodate the very high viscosity of thermoplastic polymers have involved laminating nonwoven fabrics made from the thermoplastic polymers onto sheets of carbon fibre tows or woven carbon fibre fabrics. EP-B-1473132 and EP-A-1125728 describe the use of hot roller laminating techniques to partially or fully melt a nonwoven fabric onto a carbon fibre sheet. An adhesive in solution or in the form of a low melting point fibre is contained within the nonwoven fabric. The laminating process may involve the use of one layer of a nonwoven fabric. Two layers of a nonwoven fabric may be used to sandwich the sheet of carbon fibre tows.

In order to form a nonwoven fabric, the constituent thermoplastic fibres have to be entangled or bonded in such a way as to give the fabric integrity. Consequently individual thermoplastic fibres are unable to penetrate the interstices of the carbon filaments in the carbon fibre tows. When the thermoplastic fibres of the nonwoven fabric are melted, the wicking effect of the interstices does not occur and the lengths of the carbon filaments are not fully wetted. The result is weaker interfacial bonding between the carbon filaments and the thermoplastic matrix and this is reflected in the mechanical properties of the final product.

A further disadvantage which is associated with bonding a nonwoven fabric onto a sheet of carbon fibre tows is that nonwoven fabrics generally have high porosities. Typically greater than 80% of the fabric volume is air spaces. At the microscopic level, when the constituent thermoplastic fibres are melted there is insufficient molten polymer to totally occupy the air spaces. As a consequence, very high pressure or special measures are required to reduce the size of air spaces during hot pressing. For high performance thermoplastic composites, the melt viscosity is significantly higher than for commonly used polymers and in such cases the use of nonwoven fabric is likely to result in a composite product with high void content and inferior mechanical properties.

The present invention seeks to improve the preparation of dry thermoplastic prepregs by adopting materials and procedures which achieve substantially complete wetting of reinforcing filaments in a reinforcing fibre spread tow by a thermoplastic polymer in the form of discrete (non-bonded) fibres.

Thus viewed from a first aspect the present invention provides a process for preparing a dry thermoplastic prepreg comprising:
(A) transferring reinforcing fibre spread tow continuously between the upstream end and the downstream end of an assembly;
(B) depositing airborne or melt-borne discrete thermoplastic fibres onto the reinforcing fibre spread tow in a deposition zone between the upstream end and the downstream end of the assembly during step (A); and
(C) capturing the dry thermoplastic prepreg at the downstream end of the assembly.

The process of the invention prepares dry thermoplastic prepregs in which discrete thermoplastic fibres are distributed uniformly amongst reinforcing filaments to facilitate the subsequent fabrication of high performance ultra-lightweight reinforced thermoplastic composites. In particular, the dry thermoplastic prepreg is flexible and drapable to render fabrication of reinforced thermoplastic composites which are lightweight with complex shapes more straightforward and rapid.

Without wishing to be bound by theory, it is noted that in step (B) of the process of the invention, discrete thermoplastic fibres are deposited individually and can pack more closely to reduce void space. Thus for example when the dry thermoplastic prepreg is heated and consolidated into a reinforced thermoplastic composite, the fibre ends that are in position within the interstices initiate wicking along the lengths of the reinforcing filaments and the small void spaces can become filled with a flow of thermoplastic polymer. Typically the void content of the reinforced thermoplastic composite is 1% or less.

Prior to step (C) the process may further comprise:
(C0) elevating the temperature of the discrete thermoplastic fibres downstream from the deposition zone.

In step (C0), the temperature of the discrete thermoplastic fibres may be elevated to above the glass transition temperature of the thermoplastic polymer but below its melting point. Step (C0) serves to stabilise the product of step (B) by enabling the discrete thermoplastic fibres to become tacky and adhere to each other and to the reinforcing filaments of the reinforcing fibre spread tow.

Step (C0) may serve to commingle the discrete thermoplastic fibres and the reinforcing filaments of the reinforcing fibre spread tow to form yarn.

Alternatively or additionally prior to step (C) the process of the invention may further comprise:
(C00) commingling the discrete thermoplastic fibres and the reinforcing filaments of the reinforcing fibre spread tow downstream from the deposition zone to form yarn.

In step (C00), commingling may be carried out by an air jet.

The reinforcing fibre spread tow may be carbon fibre spread tow, boron fibre spread tow, boron nitride fibre spread tow, silicon carbide fibre spread tow, silicon nitride fibre spread tow, alumina fibre spread tow, glass fibre spread tow, ceramic fibre spread tow, metal fibre spread tow or quartz fibre spread tow.

Preferably the reinforcing fibre spread tow is carbon fibre spread tow.

The reinforcing fibre spread tow may be a sheet of reinforcing fibre spread tows. Typically the sheet of reinforcing fibre spread tows is unidirectional (UD). The reinforcing fibre spread tow may be formed from continuous reinforcing filaments. The reinforcing fibre spread tow may additionally incorporate discontinuous reinforcing fibres such as virgin fibres, recycled fibres, reclaimed fibres or blends thereof.

The thermoplastic polymer may be a polyester (eg polyethylene terephthalate (PET)), polyamide, polyethersulphone, polyimide, polyamidoimide, polyetherimide, polyalkene (eg polyethylene (PE) or polypropylene (PP)) or a high viscosity polymer such as a polyalkyl or polyaryl sulphide (eg polyethylene sulphide or polyphenylene sulphide (PPS)).

The process may further comprise: (B0) generating discrete thermoplastic fibres from a thermoplastic polymer.

The thermoplastic polymer may be in the form of beads, pellets or chips.

The discrete thermoplastic fibres may be or include discrete thermoplastic filaments. The thermoplastic fibres may be present in a blend of discrete thermoplastic fibres and discontinuous reinforcing fibres such as virgin fibres, recycled fibres, reclaimed fibres or blends thereof.

Prior to step (B) the process may further comprise: (B00) incorporating discontinuous reinforcing fibres within the airborne or melt-borne discrete thermoplastic fibres.

The discrete thermoplastic fibres (and any discontinuous reinforcing fibres) may have a staple length. The staple length may be 5000 μm or more, preferably in the range 5 to 40 mm, particularly preferably in the range 10 to 20 mm. Typically the diameter of the discrete thermoplastic fibres is in the range 5 to 20 μm.

The discrete thermoplastic fibres may be multi-component (eg bi-component) thermoplastic composite fibres. An additional component fibre of the multi-component thermoplastic composite fibre may be an inorganic functional additive (such as carbon nanotubes or carbon black) which provides conductive properties. Alternatively an additional component fibre of the multi-component thermoplastic composite fibre may be an additional polymer. The thermoplastic polymer and additional polymer may have a selective morphological cross-section (eg sheath-core, island-in-the-sea or segmented splittable-type composite fibres).

In step (B), the discrete thermoplastic fibres may achieve a covering in the range 5 to 30 gm⁻².

Preferably step (B) comprises: (B′) pneumatically conveying the discrete thermoplastic fibres to the deposition zone.

Step (B′) may be: pneumatically conveying the discrete thermoplastic fibres from a fibre-generating device to the deposition zone.

The discrete thermoplastic fibres may be pneumatically conveyed from the fibre-generating device by blowing.

Step (B′) may be: pneumatically conveying the discrete thermoplastic fibres from the surface of an adjacent carrier to the deposition zone.

Preferably the adjacent carrier is an adjacent rotary carrier. The adjacent rotary carrier may be one or more rollers (eg perforated rollers). In this embodiment step (B′) advantageously forms a core-shell composite yarn.

The discrete thermoplastic fibres may be pneumatically conveyed from the surface of the adjacent carrier by suction.

In a first preferred embodiment, the discrete thermoplastic fibres are melt-borne.

In the first preferred embodiment prior to step (B), the process may further comprise: (B000) passing the reinforcing fibre spread tow through a molten thermoplastic polymer extruder (eg a slot die extruder) and depositing a coating of the thermoplastic polymer onto the reinforcing fibre spread tow.

Particularly preferably, step (B) comprises:
(B1) extruding a thermoplastic polymer melt through multiple orifices of a rotary extrusion die and
(B2) exposing the thermoplastic polymer melt emergent from the multiple orifices of the rotary extrusion die to an air stream.

The air stream is typically at an elevated temperature. The rotary extrusion die may be rotated at several hundred revolutions per minute (preferably <1000 rpm).

More preferably the air stream is an impinging air stream which serves to attenuate the thermoplastic polymer melt emergent from the multiple orifices of the rotary extrusion die.

The air stream may serve to convey the thermoplastic polymer melt emergent from the multiple orifices of the rotary extrusion die to the deposition zone.

Alternatively more preferably, step (A) includes: transferring the reinforcing fibre spread tow substantially centrally through a leading end and a trailing end of the rotary extrusion die and step (B2) is:
(B2a) exposing the thermoplastic polymer melt emergent from the multiple orifices of the rotary extrusion die to a substantially co-directional (eg parallel) air stream whereby to wrap discrete thermoplastic filaments onto the reinforcing fibre spread tow in the deposition zone beyond the trailing end of the rotary extrusion die.

Alternatively particularly preferably, step (A) includes: transferring the reinforcing fibre spread tow substantially centrally through a leading end and a trailing end of a hollow rotary spindle and the process further comprises:
(B1′) feeding a thermoplastic polymer melt into the leading end of the hollow rotary spindle whereby to wrap discrete thermoplastic filaments onto the reinforcing fibre spread tow in the deposition zone in the hollow rotary spindle.

In these embodiments, steps (B2a) and (B1′) advantageously form a core-shell composite yarn.

Alternatively particularly preferably, step (B) comprises:
(B1″) spraying a thermoplastic polymer melt through one or more fibre spray nozzles to convey melt-borne discrete thermoplastic fibres to the deposition zone.

In a second preferred embodiment, the discrete thermoplastic fibres are airborne.

Particularly preferably, step (B) comprises:
(B1″) mechanically disentangling a thermoplastic polymer entanglement into aligned thermoplastic polymer fibres and
(B2″) pneumatically conveying the aligned thermoplastic polymer fibres to the deposition zone in the form of airborne discrete thermoplastic fibres.

Step (B1″) may be carried out by passing the thermoplastic polymer entanglement between differentially moving surfaces covered with card clothing (eg saw-tooth card clothing).

The process of the invention may further comprise:
(A′) spreading a reinforcing fibre tow to form the reinforcing fibre spread tow.

Step (A′) typically spreads the reinforcing fibre tow by a factor of up to five times its width. Step (A′) may be carried out before or during step (A). Step (A′) may be carried out before or during step (B).

Step (A′) may comprise: subjecting the reinforcing fibre tow to forced airflow. Forced airflow may be generated by blowing or suction.

Step (A′) may comprise: supporting the reinforcing fibre tow on a mechanical spreader adapted to promote lateral movement (eg separation) of the reinforcing filaments.

Prior to (eg immediately prior to) step (B), the process may further comprise: (B0000) supporting the reinforcing fibre spread tow on a mechanical spreader adapted to promote lateral movement (eg separation) of the reinforcing filaments.

The mechanical spreader may be an oscillatory or vibratory spreader. For example, the mechanical spreader may be an oscillating mechanical bar or vibratory roller.

Preferably step (B) comprises:
(B″) subjecting the reinforcing fibre spread tow in the deposition zone to forced airflow.

The forced airflow in step (B″) may be applied to the surface of the reinforcing fibre spread tow opposite to the deposition face (eg from beneath the reinforcing fibre spread tow).

Step (B″) may serve to promote the patency of the interstices amongst the filaments of the reinforcing fibre spread tow. This advantageously maximises the level of deposition of discrete thermoplastic fibres in step (B).

Particularly preferably in step (B″) the forced airflow is generated by blowing.

Particularly preferably in step (B″) the forced airflow is generated by suction.

Particularly preferably in step (B″) the forced airflow is generated by blowing and suction.

In a preferred embodiment, the process further comprises
(A″) separating the reinforcing fibre spread tow lengthwise into multiple reinforcing filament ribbons.

The reinforced fibre spread tow may be separated into reinforcing filament ribbons of 1k to 6k or more (eg 1k, 3k, or 6k). By way of example, a 12K carbon fibre spread tow of width 20 mm may be separated lengthwise into four 3K carbon filament ribbons each of width 5 mm. The advantage of using carbon filament ribbons over carbon fibre spread tow is that the dry thermoplastic prepreg can be more easily woven on conventional high speed looms.

In step (A″) the reinforcing fibre spread tow may be separated lengthwise by cutting (eg slitting) or by dividing and peeling. Preferred is dividing and peeling which minimises lateral disruption to reinforcing fibres.

Preferably the dry thermoplastic prepreg takes the form of a core-shell composite yarn. The core-shell composite yarn may have a core of reinforcing fibre spread tow and a periphery of thermoplastic fibres.

The dry thermoplastic prepreg prepared by the process of the invention may be non-consolidated or partially consolidated.

In a preferred embodiment, the dry thermoplastic prepreg is subjected to one or more processing steps to form a processed structure.

The processed structure may be a tape, panel, sheet, laminate (eg multiaxial laminate) or cellular structure.

The (or each) processing step may be cutting, stacking, weaving or laminating. Lamination may be carried out by (for example) a lay-up step. For example, cut lengths of the dry thermoplastic prepreg may be stacked to fabricate an ultra-lightweight laminate suitable for thermoforming or rapid manufacturing of profiled composites.

Preferably the processing step is a multiaxial (eg biaxial) lay-up step and the processed structure is a multiaxial preconsolidated prepreg.

Viewed from a further aspect the present invention provides a method for fabricating a reinforced thermoplastic composite comprising:
(i) partially or fully consolidating the dry thermoplastic prepreg prepared in the process described hereinbefore or a processed structure thereof to form a reinforced thermoplastic composite.

The reinforced thermoplastic composite may be unidirectional. The reinforced thermoplastic composite may be processed into a woven form.

Step (i) may be carried out by heating and optionally by applying pressure. For example, step (i) may comprise: passing the dry thermoplastic prepreg between heated rollers or heated and pressurised rollers (eg heated calendar rollers). Heating may serve to elevate the temperature of the dry thermoplastic prepreg to beyond the melting point of the thermoplastic polymer.

The method may further comprise: (ii) infusing the dry thermoplastic prepreg with a thermoset material (eg an epoxy resin) and curing the infused dry thermoplastic prepreg.

The thermoplastic fibres may be soluble in the thermoset material. Thermoplastics soluble in a thermoset material include polyimides, polysulphones, polyethersulphones, polyamidoimides, polyetherimides and phenoxy materials such as poly(hydroxyl ethers) of bisphenol A.

The thermoplastic fibres may be insoluble in the thermoset material. Thermoplastics insoluble in a thermoset material include polyesters, polyamides and polypropylenes. By not dissolving in the thermoset material, the filamentary form of the discrete thermoplastic fibres is retained. This is advantageous for properties such as impact resistance in comparison to ill-defined forms which are obtained by phase separation with soluble fibres.

Viewed from a yet further aspect the present invention provides an assembly for preparing a dry thermoplastic prepreg comprising:
a transfer mechanism for transferring reinforcing fibre spread tow continuously between the upstream end and the downstream end of the assembly;
a deposition system for depositing airborne or melt-borne discrete thermoplastic fibres onto the reinforcing fibre spread tow in a deposition zone between the upstream end and the downstream end of the assembly; and
a carrier for capturing the dry thermoplastic prepreg at the downstream end of the assembly.

In the assembly of the invention, the reinforcing fibre spread tow, the thermoplastic polymer, the discrete thermoplastic fibres and the dry thermoplastic prepreg may be as hereinbefore defined.

The assembly may further comprise: a heater for elevating the temperature of the discrete thermoplastic fibres downstream from the deposition zone. The temperature of the discrete thermoplastic fibres may be elevated to above the glass transition temperature of the thermoplastic polymer but below its melting point.

The assembly may further comprise: a fibre-generating device for generating discrete thermoplastic fibres from a thermoplastic polymer.

The assembly may further comprise: a hopper for storing the thermoplastic polymer and a feeder for feeding the thermoplastic polymer to the fibre-generating device. The feeder may be an extruder shaft or screw which forces the thermoplastic polymer from the hopper to the fibre-generating device. The fibre-generating device may include consecutive heating zones which expose the thermoplastic polymer to an incremental temperature until it forms a thermoplastic polymer melt at the desired melt temperature.

In a preferred embodiment, the fibre-generating device is:
a rotary extrusion die with multiple orifices for extruding a thermoplastic polymer melt and
an air stream generator for generating an air stream which is coincident with the thermoplastic polymer melt emergent from the multiple orifices of the rotary extrusion die.

Particularly preferably the air stream generator generates an impinging air stream which serves to attenuate the thermoplastic polymer melt emergent from the multiple orifices of the rotary extrusion die.

The air stream generator may generate an air stream which serves to convey the thermoplastic polymer melt emergent from the multiple orifices of the rotary extrusion die to the deposition zone.

Alternatively particularly preferably, the air stream generator generates a substantially co-directional (eg parallel) air stream whereby to wrap discrete thermoplastic filaments onto the reinforcing fibre spread tow in the deposition zone beyond the trailing end of the rotary extrusion die.

In an alternative preferred embodiment, the fibre-generating device is:
a hollow rotary spindle and
a feeder for feeding a thermoplastic polymer melt into a leading end of the hollow rotary spindle.

In an alternative preferred embodiment, the fibre-generating device is:
one or more fibre spray nozzles for spraying a thermoplastic polymer melt to convey melt-borne discrete thermoplastic fibres to the deposition zone.

In an alternative preferred embodiment, the fibre-generating device is:
a mechanical disentangler for mechanically disentangling a thermoplastic polymer entanglement into aligned thermoplastic polymer fibres and
a device for pneumatically conveying the aligned thermoplastic polymer fibres to the deposition zone in the form of airborne discrete thermoplastic fibres.

The deposition system may comprise: a device for pneumatically conveying the discrete thermoplastic fibres from the fibre-generating device to the deposition zone. The device for pneumatically conveying may be a suction device or blowing device.

The deposition system may comprise: an adjacent carrier for carrying the discrete thermoplastic fibres adjacent to the deposition zone. Preferably the adjacent carrier is an adjacent rotary carrier. The adjacent rotary carrier may be one or more rollers (eg perforated rollers).

The assembly may further comprise: a molten thermoplastic polymer extruder (eg a slot die extruder) for depositing a coating of the thermoplastic polymer onto the reinforcing fibre spread tow upstream from the deposition zone.

The assembly may further comprise: means for exposing the reinforcing fibre spread tow to forced airflow in the deposition zone. The means for exposing may be a blowing and/or suction means. The forced airflow may be applied to the surface of the reinforcing fibre spread tow opposite to the deposition face (eg from beneath the reinforcing fibre spread tow).

The assembly may further comprise: a perforated support for supporting the reinforcing fibre spread tow in the deposition zone. The perforated support may be a plate or mesh.

The assembly may further comprise: a mechanical spreader for supporting the reinforcing fibre spread tow adjacent to the deposition zone, wherein the mechanical spreader is adapted to promote lateral movement (eg separation) of the reinforcing filaments. The mechanical spreader may be an oscillatory or vibratory spreader. For example, the mechanical spreader may be an oscillating mechanical bar or vibratory roller.

Preferably the assembly further comprises upstream from the deposition zone: a separation assembly for separating the reinforcing fibre spread tow lengthwise into multiple reinforcing filament ribbons.

The separation assembly may comprise:
a feed spool carrying the reinforcing fibre spread tow;
a pair of feed rollers configured to withdraw the reinforcing fibre spread tow under tension from the feed spool;
a grooved roller to which is continuously transferred the reinforcing fibre spread tow under tension, wherein the grooved roller is equipped with circular projections which serve to divide the leading end of the reinforcing fibre spread tow into divided leading ends of the multiple reinforcing filament ribbons; and
a set of spaced apart wind-up spools under tension to each of which is selectively transferred one of the divided leading ends whereby to continuously separate the reinforcing fibre spread tow lengthwise into the multiple reinforcing filament ribbons.

The grooved roller may be positioned upstream or downstream from the pair of feed rollers. The grooved roller rotates at the same or a higher speed than the feed spool. The grooved roller rotates at the same or a higher speed than the feed rollers.

Preferably the tension ratio of the feed roller to the feed spool is 1.5 or less, particularly preferably 1.25 or less, more preferably less than 1.05.

The geometry of the grooved roller may be selected to provide splitting of a 12k carbon fibre spread tow into ribbons of 1k to 6k or more (eg 1k, 3k, or 6k).

Alternatively the separation assembly may comprise:
a feed spool carrying the reinforcing fibre spread tow;
a separator roller and an adjacent roller between which is continuously transferred the reinforcing fibre spread tow under tension, wherein the separator roller is equipped with circular projections which serve to divide the leading end of the reinforcing fibre spread tow into divided leading ends of the multiple reinforcing filament ribbons; and
a set of spaced apart wind-up spools under tension to each of which is selectively transferred one of the divided leading ends whereby to continuously separate the reinforcing fibre spread tow lengthwise into the multiple reinforcing filament ribbons.

Alternatively the separation assembly may comprise:
a feed spool carrying the reinforcing fibre spread tow;
a pair of feed rollers configured to withdraw the reinforcing fibre spread tow under tension from the feed spool;
a cutting roller to which is continuously transferred the reinforcing fibre spread tow under tension, wherein the cutting roller is equipped with knife-edge projections which serve to continuously slit lengthwise the reinforcing fibre spread tow into the multiple reinforcing filament ribbons; and
a set of spaced apart wind-up spools under tension to each of which is selectively transferred one of the multiple reinforcing filament ribbons.

Preferably the assembly further comprises: a consolidator for partially or fully consolidating the dry thermoplastic prepreg to form a reinforced thermoplastic composite.

The consolidator may apply heat and/or pressure. The consolidator may be heated rollers or heated and pressurised rollers (eg heated calendar rollers).

The carrier may be a spool, creel or bobbin.

The assembly may further comprise a lay-up arrangement for performing multiaxial (eg biaxial) lay-up of the dry thermoplastic prepreg to form a multiaxial laminate upstream from the downstream end of the assembly.

Preferably the lay-up arrangement comprises a first transfer mechanism for transferring a first dry thermoplastic prepreg along a first axis in a horizontal plane, a second transfer mechanism for transferring a second dry thermoplastic prepreg along a second axis in the horizontal plane to be laid across the first dry thermoplastic prepreg and optionally one or more additional transfer mechanisms for transferring one or more additional dry thermoplastic prepregs along additional axes in the horizontal plane to be laid across the first dry thermoplastic prepreg and the second dry thermoplastic prepreg, wherein the first axis is different from the second axis. The additional axes may be different from the first axis and/or second axis.

Viewed from a still yet further aspect the present invention provides a dry thermoplastic prepreg as hereinbefore defined or obtainable from a process as hereinbefore defined or a processed structure thereof.

Preferably the dry thermoplastic prepreg takes the form of a core-shell composite yarn. The core-shell composite yarn may have a core of reinforcing fibre spread tow and a periphery of thermoplastic fibres.

The dry thermoplastic prepreg may be non-consolidated or partially consolidated.

The areal weight of the dry thermoplastic prepreg is dependent on the volume ratio of the reinforcing fibre spread tow and thermoplastic fibres but is typically in the range 40 g/m² to 80 g/m², preferably 50 g/m² to 70 g/m². For example where the volume ratio of discrete thermoplastic fibres to reinforcing fibre spread tow is 1:1, the areal weight may be in the range 65 g/m² to 75 g/m².

Viewed from an even still yet further aspect the present invention provides a reinforced thermoplastic composite as hereinbefore defined or obtainable from a method as hereinbefore defined.

Typically the void content of the reinforced thermoplastic composite is 1% or less. Preferably the void content of the reinforced thermoplastic composite is in the range 0.2 to 1%, particularly preferably in the range 0.2 to 0.6%, more preferably in the range 0.2 to 0.5% (eg about 0.45%).

The density of the reinforced thermoplastic composite may be in the range 1.580 to 1.610 g/cm³ (eg about 1.600 g/cm³).

The fibre volume fraction of the reinforced thermoplastic composite may be in the range 52 to 63%, preferably in the range 55 to 60% (eg about 57%).

The flexural modulus of the reinforced thermoplastic composite may be in the range 115-145 GPa, preferably 120-140 GPa (eg about 127 GPa).

The flexural strength of the reinforced thermoplastic composite may be in the range 1400 to 1900 MPa, preferably 1550 to 1800 MPa (eg about 1739 MPa).

The flexural failure strain of the reinforced thermoplastic composite may be in the range 1.20 to 1.70%, preferably 1.30 to 1.60% (eg about 1.50).

Fire barrier tests have shown that the reinforced thermoplastic composites of the invention exhibit advantageously high thermal resistance.

Viewed from an even further aspect the present invention provides a separation assembly as hereinbefore defined.

The present invention will now be described in a non-limitative sense with reference to Examples and Figures in which:

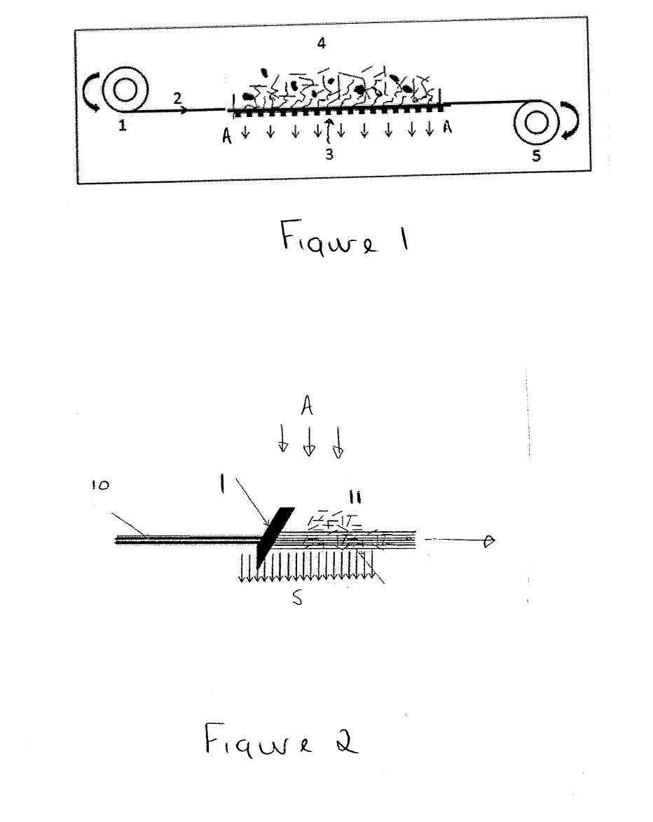

FIG. 1 illustrates in part a first embodiment of the assembly of the invention which may be used in a process for preparing a dry thermoplastic prepreg;

FIG. 2 illustrates in part a second embodiment of the assembly of the invention which may be used in a process for preparing dry thermoplastic prepreg;

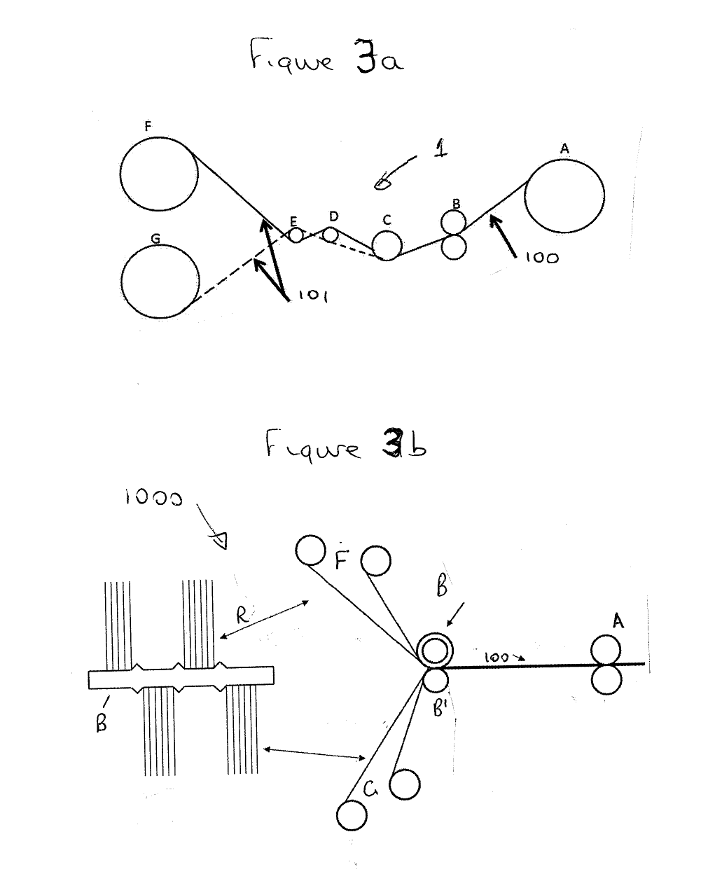

FIGS. 3(a) and 3(b) illustrate a splitting assembly which may be deployed in embodiments of the assembly of the invention;

FIG. 4 illustrates in part a third embodiment of the assembly of the invention which may be used in a process for preparing dry thermoplastic prepreg in the form of a core-shell composite yarn;

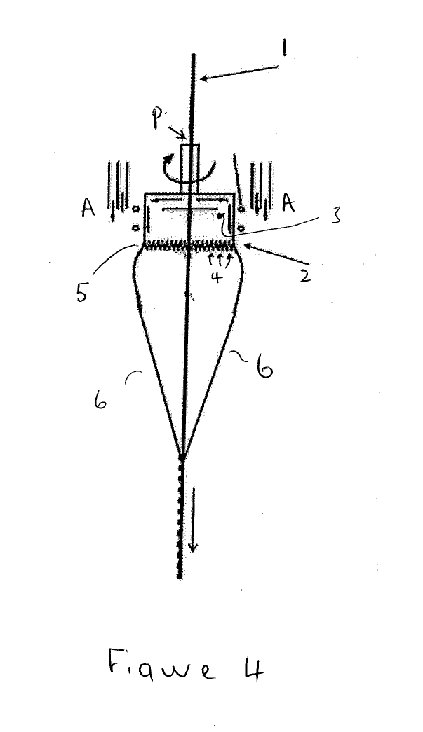

FIG. 5 shows a dry (partially consolidated) thermoplastic prepreg of carbon fibre spread tow and PPS;

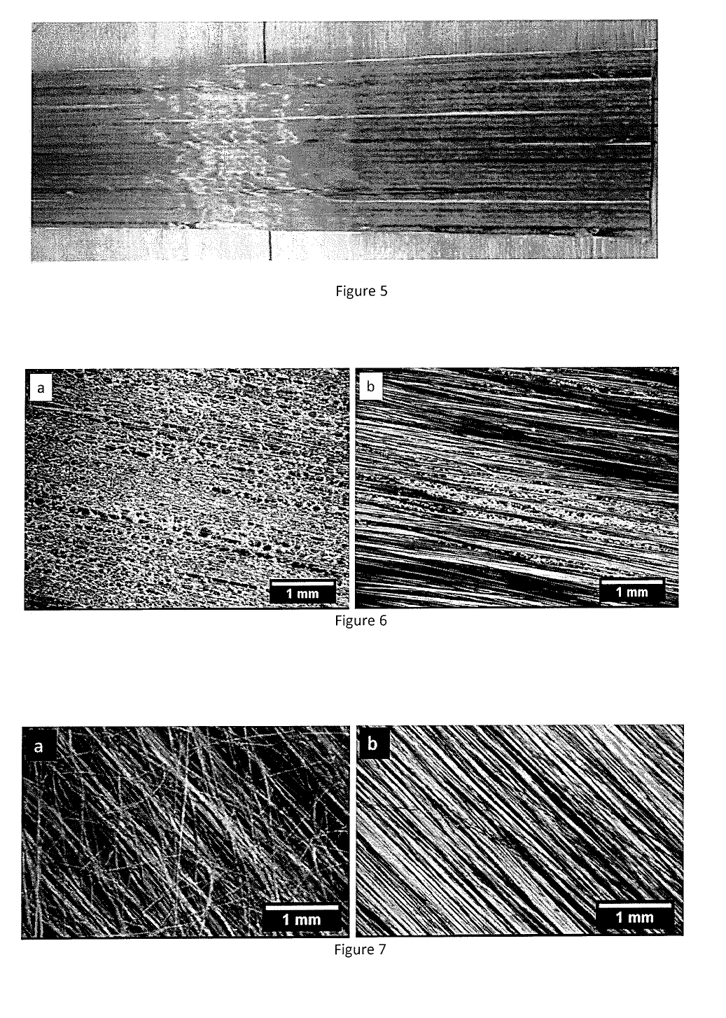

FIGS. 6a and 6b show the deposition of PPS onto surfaces of the carbon fibre spread tow;

FIGS. 7a and 7b show carbon fibre spread tow bonded (laminated) with a thermoplastic nonwoven;

FIG. 8 illustrates schematically a lay-up arrangement which may be deployed in embodiments of the assembly of the invention;

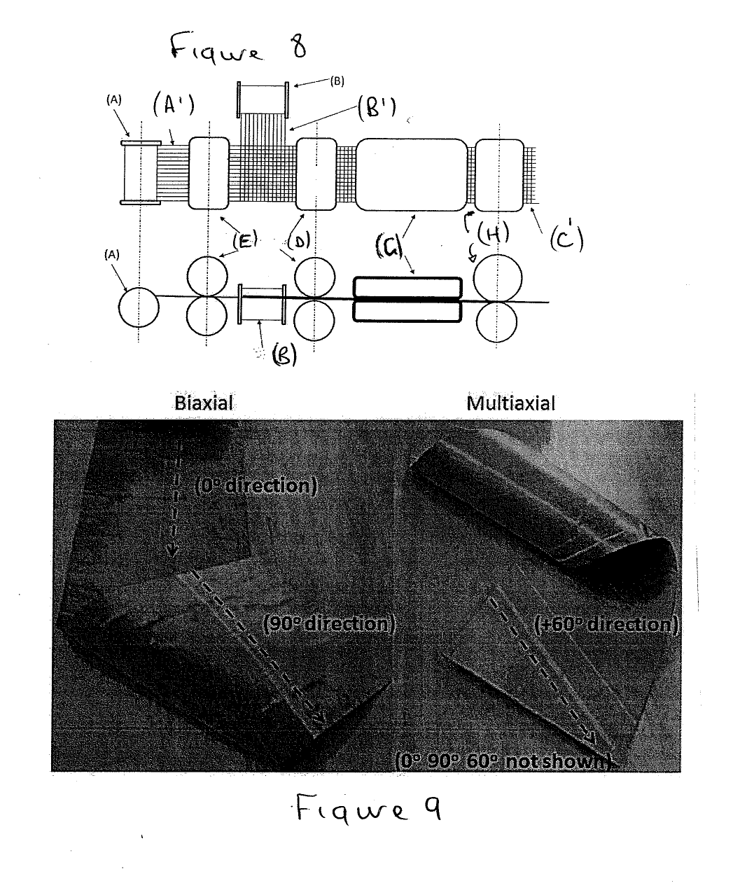

FIG. 9 illustrates biaxial and multiaxial preconsolidated prepregs prepared according to the process of the invention;

FIG. 10 illustrates an ultra-lightweight cellular structure formed by processing a dry thermoplastic prepreg prepared according to the process of the invention;

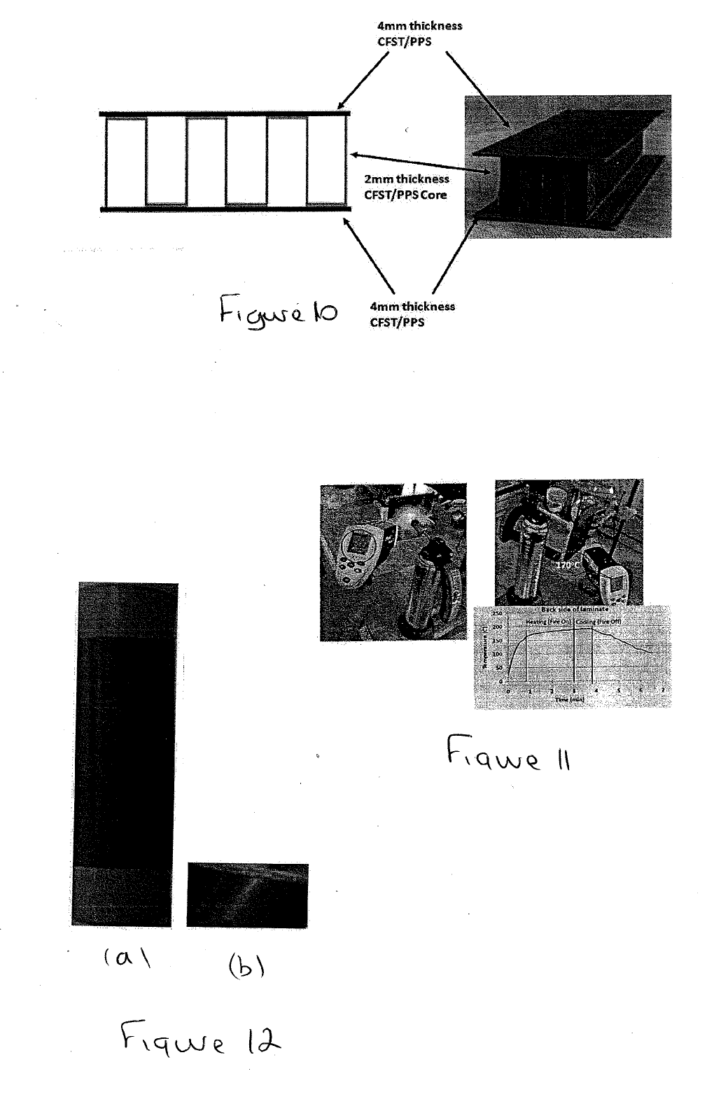

FIG. 11 illustrates the results of a fire barrier test carried out on a fully consolidated laminate made from a dry thermoplastic prepreg prepared according to the process of the invention; and

FIG. 12 illustrates tape cut from a consolidated composite made from a dry thermoplastic prepreg prepared according to the process of the invention.

### EXAMPLE 1

FIG. 1 illustrates in part a first embodiment of the assembly of the invention which may be used in a process for preparing a dry thermoplastic prepreg using carbon fibre spread tow and a thermoplastic polymer such as PP, PET or PPS as the matrix. An embodiment of the process is described below (Process 1).

In the first embodiment of the assembly of the invention in use, carbon fibre spread tow 2 is pulled from a feeding package 1 across a wire mesh 3 of polished stainless steel (30 μm diameter holes and 282 holes/cm²) to a take-up or winding device 5. A molten flow of discrete fibres 4 of the thermoplastic polymer (equivalent to 5-30 gm⁻²) is conveyed from a fibre-generating device (not shown) positioned directly above the area of the wire mesh 3 to the carbon fibre spread tow 2. The assembly further comprises a feed hopper and a 3-heated-zone screw extruder (not shown) which feed molten thermoplastic polymer to the fibre-generating device. The fibre-generating device includes a spinneret plate having 1000 holes of 20 μm diameter with a narrow venturi slot (5 μm) situated after the spinneret plate.

Air suction (A) is applied from beneath the surface of the wire mesh 3 to maintain the openness of the carbon fibre spread tow 2 whilst the molten flow guides the discrete fibres 4 of the thermoplastic polymer into its interstices. The ends of the discrete fibres 4 penetrate the carbon fibre spread tow 2 but the length of the discrete fibres 4 (>5000 μm) is many times greater than the thickness of the carbon fibre spread tow 2 (<40 μm) and the discrete fibres 4 will not pass through fully. Before being wound up by the winding device 5, the deposition is stabilized by heating to a temperature above the glass transition temperature (Tg) of the thermoplastic polymer using heated calendar rollers (not shown). This enables the discrete fibres 4 to become tacky and adhere to each other and to the surfaces of the carbon filaments of the carbon fibre spread tow 2.

### Process 1

A sheet consisting of 12 carbon fibre spread tows 2 laid parallel to each other was pulled at a speed of 5 m/min across the wire mesh 3. Air suction was applied at a flow rate of 100 l/min through a surface area of 62.5 cm² of the wire mesh 3 referred to as the suction zone. The feed hopper was charged with PP resin chips. A compressed air supply (110 bar) was connected to the venturi so that as the molten PP was extruded through the holes of the spinneret, the accelerated airflow attenuated each molten PP filament into 5-10 μm and broke them into short lengths (>5000 μm) while solidifying and guiding them to the suction zone. As the sheet of carbon fibre spread tows 2 was withdrawn from the suction zone by the winding device 5, the deposited PP fibres were thermally bonded using heated calendar rollers at a temperature of 120° C. The stabilised dry thermoplastic prepreg was then wound into a package by the winding device 5.

### EXAMPLE 2

FIG. 2 illustrates in part a second embodiment of the assembly of the invention which may be used in a process for preparing dry thermoplastic prepreg using carbon fibre spread tow and a thermoplastic polymer such as PP, PET or PPS as the matrix.

The elements of the second embodiment of the assembly of the invention which transfer a carbon fibre spread tow 10 are similar to those described in Example 1 above but the fibre-generating device (not shown) is different. In this embodiment, short discrete thermoplastic fibres 11 from a saw-tooth wire covered surface of a carding machine are conveyed by blowing air A towards the carbon fibre spread tow 10. A vibratory spreader 1 is used to promote separation of the filaments in the carbon fibre spread tow 10. Air suction S is applied from beneath to maintain the separation of the filaments in the carbon fibre spread tow 10 and to assist the blowing air A to convey the thermoplastic fibres 11 to the carbon fibre spread tow 10.

### EXAMPLE 3

Each of FIGS. 3(a) and 3(b) illustrate a separation assembly which may be deployed in embodiments of the assembly of the invention to split carbon fibre spread tow into carbon filament ribbons.

In FIG. 3(a), the separation assembly 1 comprises a feed spool (A) on which 12k carbon fibre spread tow 100 is wound during spreading. The carbon fibre spread tow 100 is nipped by a pair of feed rollers (B) which pull it from the feed spool (A) enabling it to pass beneath a specially designed grooved roller (C). The number and width of the grooves on the grooved roller (C) defines the number and width of the ribbons into which the 12K carbon fibre spread tow 100 is separated. The circular projections of the grooved roller (C) initiate the separation of the carbon fibre spread tow 100 by dividing its leading end into four narrow widths. Each width is the start of one 3k filament ribbon. The grooved roller (C) rotates at least at the same speed as the feed spool (A). Downstream from the grooved roller (C) are a pair of upper wind-up spools (F) and a pair of lower wind-up spools (G) attached to two tension controlling motors (not shown). On departing the grooved roller (C), the four individual ribbons are threaded around two separating bars (D & E) so that the ribbons pass sequentially across the assembly width alternately to one of the upper wind-up spools (F) and one of the lower wind-up spools (G). The filaments in one 3K filament ribbon collectively peel away from the filaments in an adjacent 3K filament ribbon. By threading the ribbons around the separating bars (D &E) they are kept separate and the associated tension enables continuous peeling.

In FIG. 3(b), the separation assembly 1000 comprises a feed spool (A) on which 12k carbon fibre spread tow 100 is wound during spreading. The carbon fibre spread tow 100 is passed between a rotary separator roller (B) and bottom steel roller (B′) that divide the leading end of the 12k carbon fibre spread tow 100 into four narrow widths. Each width is the start of one 3k filament ribbon. Downstream from the separator roller (B) and bottom steel roller (B′) are a pair of upper wind-up spools (F) and a pair of lower wind-up spools (G) attached to two tension controlling motors (not shown). On departing the separator roller (B) and bottom steel roller (B′), the four individual ribbons (R) pass sequentially across the assembly width alternately to one of the upper wind-up spools (F) and one of the lower wind-up spools (G).

Use of the Separation Assembly of FIG. 3(a)

12 k carbon fibre tow of width 5 mm was spread to 25 mm at a production speed of 5 m/min. The feed spool (A) was transferred to the separation machine. A grooved roller (C) with four grooves was used to divide the 12k carbon fibre spread tow into four 3k filament ribbons. This was achieved by operating the grooved roller (C) and the pair of feed rollers (B) at the same surface speed of 5 m/min while winding the individual 3k filament ribbons under a tension ratio of 1.05.

Separation was also achieved by interchanging the positions of the pair of feed rollers (B) and grooved roller (C) and again running the system at 5 m/min with the same tension ratio. In this case the leading end of the 12 k carbon fibre spread tow was divided into the leading ends of four 3k filament ribbons prior to passing through the nip of the pair of feed rollers (B) and onto the wind-up spools (F and G).

### EXAMPLE 4

FIG. 4 illustrates in part a third embodiment of the assembly of the invention which may be used in a process for preparing dry thermoplastic prepreg using carbon fibre spread tow and a thermoplastic polymer such as PP, PET or PPS as the matrix. An embodiment of the process is described below (Process 2).

In the third embodiment of the assembly of the invention, an inverted centrifugal bowl 2 is fitted internally with a spreader in the form of a drop plate 3. The centrifugal bowl 2 and drop plate 3 are equipped with centrally aligned apertures through which (for example) a 3k filament ribbon 1 formed from carbon fibre spread tow in accordance with Example 3 can be pulled and wound onto a bobbin (not shown).

A series of notches or grooves 4 is cut in the rim 5 of the centrifugal bowl 2. The centrifugal bowl 2 is heated by induction heating coils to a temperature above the melting point of the thermoplastic polymer. During centrifugal spinning, the 3k filament ribbon 1 is pulled through the centrifugal bowl 2 as the thermoplastic polymer chips P are fed into the centrifugal bowl 2. The thermoplastic polymer chips P hit the drop plate 3 and are thrown onto the heated wall of the centrifugal bowl 2 where they are held by centripetal forces. As the thermoplastic polymer chips P melt, molten thermoplastic polymer flows down the wall of the centrifugal bowl 2. On reaching the rim 5, the molten thermoplastic polymer is divided by the grooves 4 into continuous rivulets of molten thermoplastic polymer which are peripherally spun from the centrifugal bowl 2 and cooled in a surrounding airstream A to form thermoplastic polymer filaments 6. The thermoplastic polymer filaments 6 initially sheath the 3k filament ribbon 1 which emerges from the centre of the centrifugal bowl 2 to form a core-shell composite yarn in the deposition zone.

The core-shell composite yarn can then be commingled by air-jet technology or by passing over heated godets to thermally tack the thermoplastic polymer filaments 6 to the carbon filaments of the 3k filament ribbon 1. With thermal tacking the thermoplastic polymer filaments 6 become aligned and parallel with the carbon filaments of the 3k filament ribbon 1 which enable them to be tacked within their interstices. This facilitates good wetting of the carbon filaments during hot-press production of a composite.

### Process 2

A 12k carbon fibre spread tow was split into four 3k filament ribbons in accordance with Example 3. A single 3k filament ribbon 1 was passed through the centrifugal bowl 2 and drop plate 3 while PP resin chips were fed into the centrifugal bowl 2 at a rate of 10 g per min. The centrifugal bowl 2 was preheated to 220° C. whilst being rotated at 800 revs/min. The centrifugal bowl 2 had a hundred grooves 4 machined into the rim 5. One hundred PP filaments of 20 μm diameter were spun at a speed of 50 m/min and sheathed the 3k filament ribbon 1 to form a core-shell composite yarn. The core-shell composite yarn was subsequently thermally treated at 120° C. to tack the PP filaments to the carbon filaments.

### EXAMPLE 4

Spreading trials of a selection of carbon fibre tows sourced from different manufacturers were carried out using the airflow tow spreading technique. Tables 1 and 2 give the characteristics of the carbon fibre pre- and post-spreading.

TABLE 1

| | | | | Estimated | | Spreading |
|---|---|---|---|---|---|---|
| | Fibre | Width | | Thickness | | ratio |
| Carbon | diameter | (mm) | | (μm) | | (After/ |
| Fibres | (μm) | Before | After | Before | After | Before) |
| 12K - GRAVIL | 8 | 6.77 | 21.70 | 113.44 | 35.39 | 3.2 |
| 12K - | 6 | 4.70 | 17.11 | 91.91 | 25.25 | 3.6 |
| MITSUBISHI | | | | | | |
| 18K - TORAY | 6 | 7.07 | 21.20 | 91.65 | 30.57 | 3.0 |
| (T700) | | | | | | |
| 12K - | 7 | 6.91 | 22.75 | 111.14 | 33.76 | 3.3 |
| HEXCEL | | | | | | |
| (AS4) | | | | | | |

TABLE 2

| | Estimated Number | | Approximate Number | |
|---|---|---|---|---|
| Carbon | of layers | | of Layers | |
| Fibres | Before | After | Before | After |
| 12K - GRAVIL | 14.18 | 4.42 | 14 | 4 |
| 12K - MITSUBISHI | 15.32 | 4.21 | 15 | 4 |
| 18K - TORAY (T700) | 15.28 | 5.09 | 15 | 5 |
| 12K - HEXCEL (AS4) | 13.89 | 4.22 | 14 | 4 |

### EXAMPLE 5

Process 1 referred to above was used to prepare a dry (partially consolidated) thermoplastic prepreg of carbon fibre spread tow and PPS which is shown in FIG. 5. FIG. 6a shows the deposition of a fine web of PPS directly onto one surface of the carbon fibre spread tow. FIG. 6b reveals the impregnation, wetting and flow characteristics from the opposite surface of the carbon fibre spread tow.

For comparative purposes, FIG. 7a shows carbon fibre spread tow bonded (laminated) with a thermoplastic nonwoven from the top surface. FIG. 7b shows the opposite surface looking through the carbon fibre spread tow. By comparing FIG. 6b with FIG. 7b, is it clear that the melt-blown thermoplastic resin penetrated the carbon fibre spread tow but the nonwoven web did not.

The basis/areal weight of the discrete thermoplastic fibres deposited on the carbon fibre spread tow ranged from 10 g/m² to 30 g/m². Table 3 gives the areal weight of the dry thermoplastic prepregs of carbon fibre spread tow (12k, 40 g/m²) and PPS at different volume ratios.

TABLE 3

| CFST/PPS | Areal weight |
|---|---|
| (% by volume) | (g/m²) |
| 75/25 | 50 |
| 60/40 | 60 |
| 50/50 | 70 |

Table 4 summarises average values of physical and flexural properties of UD composite panels made from the dry thermoplastic prepregs of carbon fibre spread tow and PPS (according to ISO 14125 and ISO 1172).

TABLE 4

| Property | Average | Range |
|---|---|---|
| Density (g/cm³) | 1.600 | 1.580-1.610 |
| Fibre Volume | 57 * | 55-60 |
| Fraction (%) | | |
| Voids Content (%) | 0.45 ** | 0.2-1.0 |
| Flexural Modulus | 127 | 120-140 |
| (GPa) | | |
| Flexural Strength | 1739 | 1550-1800 |
| (MPa) | | |
| Flexural Failure | 1.50 | 1.20-1.70 |
| Strain (%) | | |

* Burn out test
** Calculated values

### EXAMPLE 6

Dry thermoplastic prepreg prepared according to the process of the invention can be used to produce reinforced thermoplastic composite laminates having desirable properties (such as those shown in Table 4) and as such can be used for the following applications:
1. To produce biaxial or multiaxial preconsolidated prepregs
2. To produce ultra-light weight (sandwiched-core) sheets typically in the range 25 mm-100 mm
3. Fire protection barriers
4. Tape laying for the production of complex-shape composite structures.

### Biaxial and Multiaxial Preconsolidated Prepregs

Traditional biaxial and multiaxial sheet materials for composites are produced by stitching together two sheets of reinforcing fibre tows laid at right angles to each other (biaxial) or four or more sheets arranged at various angles to each other (multiaxial). The stitching action is known in the textile industry as warp knitting. The process is cumbersome and expensive, and the stitching action can break reinforcing fibres. The dry thermoplastic prepreg prepared by the process of the invention can avoid these disadvantages.

FIG. 8 illustrates a first roll of the dry thermoplastic prepreg (A) positioned to enable a first sheet (A′) of dry thermoplastic prepreg to move continuously in the horizontal plane (0° direction). A second roll of the dry thermoplastic prepreg (B) is positioned to enable a second sheet (B′) of dry thermoplastic prepreg to be laid across and at right angles to the first sheet (A′) of dry thermoplastic prepreg (90° direction) and cut to the width of the first sheet (A′). The action is then repeated so that subsequently cut sheets become juxtaposed in the 90° direction. Thus the reinforcing filaments in the cross-laid sheets of dry thermoplastic prepreg are at right angles to those in the horizontal plane thereby giving a biaxial arrangement. The 0°/90° lay-up combination is then transported via caterpillar guide belts (G) to heated calendar rollers (H) and thermally bonded to form a biaxial preconsolidated prepreg (C′).

By positioning a first additional roll of dry thermoplastic prepreg to give a sheet laid diagonally at 135° (commonly referred to as −45°) in the horizontal plane and a second additional roll of dry thermoplastic prepreg to give a sheet laid diagonally at 45° (commonly referred to as +45°) in the horizontal plane, the resulting preconsolidated prepreg is multiaxial. The first and second additional rolls may be placed between guide rollers (E) and (D) before and after roll (B) respectively. Alternatively the first and second additional rolls may both be placed before or both placed after roll (B). Further additional rolls of dry thermoplastic prepreg can be added to provide (for example) −60°/+60° and/or −30°/+30°.

Instead of cutting the cross-laid prepreg sheets, they may be reversed laid using a mechanism similar to that used in the making of cross-laid nonwoven fabrics well known to those skilled in the art of producing needle-punched nonwoven fabrics.

FIG. 9 shows examples of biaxial and multiaxial CF/PPS preconsolidated prepregs and their properties are given in Table 5.

TABLE 5

| Lay-Up | Density (g/cc) | Fibre Volume (% V_{F}) | Void Content (%) |
|---|---|---|---|
| Biaxial | 1.589 | 59.0 | 2.6 |
| Multiaxial | 1.586 | 62.2 | 0.5 |

FIG. 10 shows that a pre-consolidated or consolidated dry thermoplastic prepreg (CFST/PPS 60:40) can be made to form an ultra lightweight cellular structure where the core is carbon fibre spread tow.

Traditional cores are made from foams and the upper and lower laminate layers bonded to the core with an adhesive. The reinforcing fibre core offers the advantage of thicker cellular structures.

The weight of the cellular structure (length×width×thickness) 150 cm×150 cm×100 cm is 20 g. The weight of an equivalent solid structure is 186 g which equates to a weight saving of 89%.

FIG. 11 shows the results of a fire barrier test where a flame of 680° C. was directed onto the front surface of a fully consolidated laminate (barrier) made from a dry thermoplastic prepreg prepared according to the process of the invention. Owing to the thinness of the spread tow sheet layers, the entrapped air imparts a low thermal transfer (ie high thermal resistance) to the laminate as the front layers delaminate preventing the temperature reaching above 170° C. over a prolonged period of above 3 minutes to the end of the test period.

FIG. 12 shows that a dry thermoplastic prepreg subjected to various levels of consolidation (a) can be cut into a tape (b) to be used in a thermoplastic tape laying process.

1. A process for preparing a dry thermoplastic prepreg comprising:
(A) transferring reinforcing fibre spread tow continuously between the upstream end and the downstream end of an assembly;
(B) depositing airborne or melt-borne discrete thermoplastic fibres onto the reinforcing fibre spread tow in a deposition zone between the upstream end and the downstream end of the assembly during step (A); and
(C) capturing the dry thermoplastic prepreg at the downstream end of the assembly.

2. The process as claimed in claim 1 further comprising: prior to step (C)
(CO) elevating the temperature of the discrete thermoplastic fibres downstream from the deposition zone to above the glass transition temperature of the thermoplastic polymer.

3. The process as claimed in claim 1, wherein step (B) comprises:
(B′) pneumatically conveying the discrete thermoplastic fibres to the deposition zone.

4. The process as claimed in claim 1, wherein step (B) comprises:
(BI) extruding a thermoplastic polymer melt through multiple orifices of a rotary extrusion die and
(B2) exposing the thermoplastic polymer melt emergent from the multiple orifices of the rotary extrusion die to an air stream.

5. The process as claimed in claim 1, wherein the air stream is an impinging air stream which serves to attenuate the thermoplastic polymer melt emergent from the multiple orifices of the rotary extrusion die.

6. The process as claimed in claim 1, wherein step (A) includes: transferring the reinforcing fibre spread tow substantially centrally through a leading end and a trailing end of the rotary extrusion die and step (B2) is:
(B2a) exposing the thermoplastic polymer melt emergent from the multiple orifices of the rotary extrusion die to a substantially co-directional air stream whereby to wrap discrete thermoplastic filaments onto the reinforcing fibre spread tow in the deposition zone beyond the trailing end of the rotary extrusion die.

7. The process as claimed in claim 1, wherein step (A) includes transferring the reinforcing fibre spread tow substantially centrally through a leading end and a trailing end of a hollow rotary spindle and the process further comprises:
(B) feeding a thermoplastic polymer melt into the leading end of the hollow rotary spindle whereby to wrap discrete thermoplastic filaments onto the reinforcing fibre spread tow in the deposition zone in the hollow rotary spindle.

8. The process as claimed in claim 1, wherein step (B) comprises:
(B″) subjecting the reinforcing fibre spread tow in the deposition zone to forced airflow.

9. The process as claimed in claim 1, wherein the dry thermoplastic prepreg is subjected to one or more processing steps to form a processed structure.

10. The process as claimed in claim 9, wherein the processed structure is a tape, panel, sheet, laminate or cellular structure.

11. A method for fabricating a reinforced thermoplastic composite comprising:
(i) partially or fully consolidating a dry thermoplastic prepreg prepared in a process defined in claim 1.

12. An assembly for preparing a dry thermoplastic prepreg comprising:
a transfer mechanism for transferring reinforcing fibre spread tow continuously between the upstream end and the downstream end of the assembly;
a deposition system for depositing airborne or melt-borne discrete thermoplastic fibres onto the reinforcing fibre spread tow in a deposition zone between the upstream end and the downstream end of the assembly; and
a carrier for capturing the dry thermoplastic prepreg at the downstream end of the assembly.

13. The assembly as claimed in claim 12, further comprising: a heater for elevating the temperature of the discrete thermoplastic fibres downstream from the deposition zone to above the glass transition temperature of the thermoplastic polymer.

14. The assembly as claimed in claim 12, further comprising: a fibre-generating device for generating discrete thermoplastic fibres from a thermoplastic polymer.

15. The assembly as claimed in claim 12, further comprising: means for exposing the reinforcing fibre spread tow to forced airflow in the deposition zone.

16. The assembly as claimed in claim 12, further comprising: a perforated support for supporting the reinforcing fibre spread tow in the deposition zone.

17. The assembly as claimed in claim 12, further comprising: a mechanical spreader for supporting the reinforcing fibre spread tow adjacent to the deposition zone, wherein the mechanical spreader is adapted to promote lateral movement of the reinforcing filaments.

18. The assembly as claimed in claim 12, further comprising upstream from the deposition zone: a separation assembly for separating the reinforcing fibre spread tow lengthwise into multiple reinforcing filament ribbons.

19. The assembly as claimed in claim 12, further comprising: a lay-up arrangement for performing multiaxial lay-up of the dry thermoplastic prepreg to form a multiaxial laminate upstream from the downstream end of the assembly, wherein the lay-up arrangement comprises a first transfer mechanism for transferring a first dry thermoplastic prepreg along a first axis in a horizontal plane, a second transfer mechanism for transferring a second dry thermoplastic prepreg along a second axis in the horizontal plane to be laid across the first dry thermoplastic prepreg and optionally one or more additional transfer mechanisms for transferring one or more additional dry thermoplastic prepregs along additional axes in the horizontal plane to be laid across the first dry thermoplastic prepreg and the second dry thermoplastic prepreg, wherein the first axis is different from the second axis.

20. A dry thermoplastic prepreg obtainable from a process defined in claim 1.
